(19) United States
(12) Patent Application Publication
(10) Pub. No.: US 2001/0018722 A1
(43) Pub. Date: Aug. 30, 2001

(54) Humanized multifunction module providing to connect computer

(76) Inventor: Sophie Leu, San Chung City (TW)

Correspondence Address: Jason Z. Lin, 19597 Via Monte Drive, Saratoga, CA, 95070, US

(21) Appl. No.: 09/734,798

(22) Filed: Dec. 11, 2000

(30) Foreign Application Priority Data
Dec. 15, 1999 (TW) 88221369

(51) Int. Cl. G06F 13/00; G06F 13/38

(52) U.S. Cl. 710/129

(57) ABSTRACT

A multifunction interface module displays the working temperature, working voltage and fan speed of a CPU in an LCD display. The interface module has a single chip design and is coupled to the BIOS of a motherboard through a cable connection. A distance sensor, a temperature sensor and a light sensor may also be built in the interface module. A monitor is automatically shut down and then resumed if the distance sensor detects that a user is too close. The environmental temperature and light can be sensed and sent to the mother board by the single chip in the module to enable interaction between the outside environment and the application software in the computer.

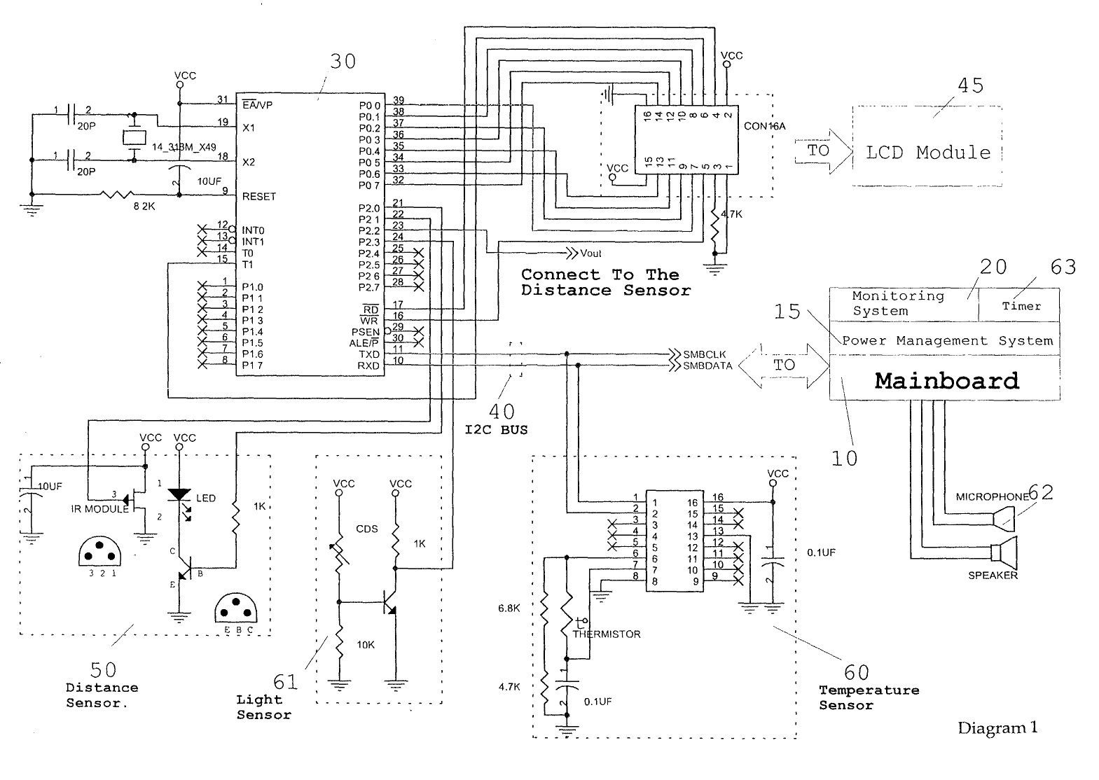

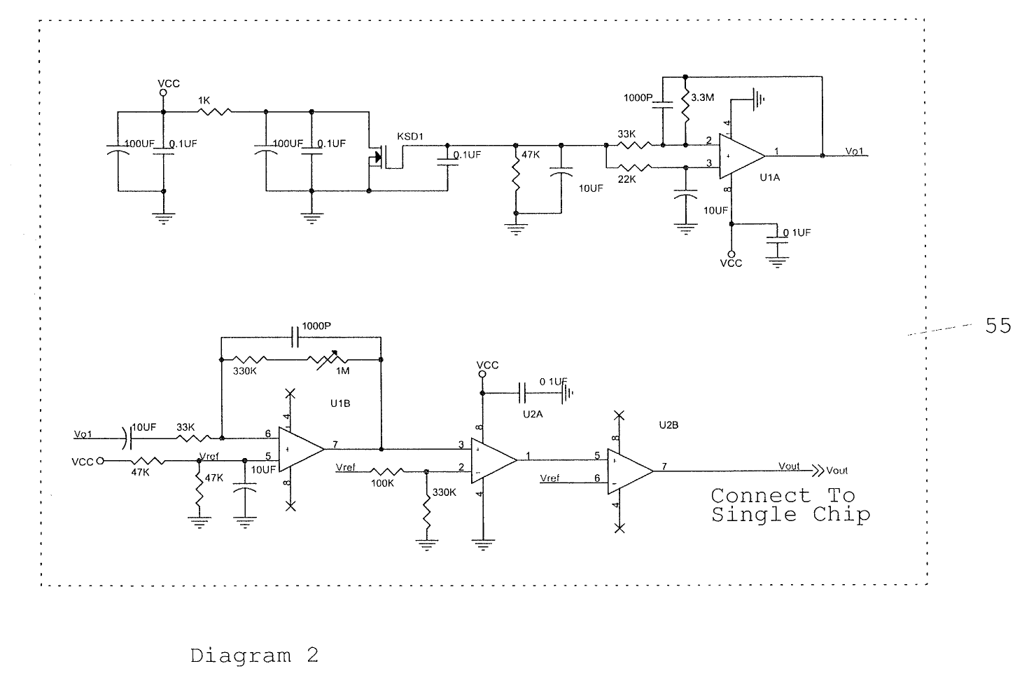

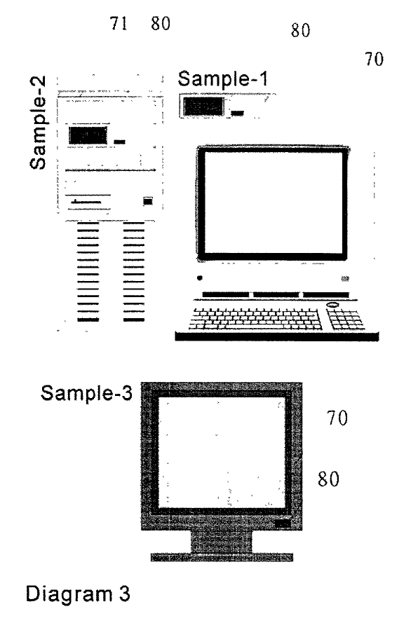

The present invention is to build an interface module for using on the computer housing or to build an independent module device. This humanized module will build in LCD panel, sensors for distance, temperature and brightness. Through the single chip design and application software programming plus voice input and timer setting featured in the computer, the module will communicate with the computer and software (such as entertainment game) to achieve humanized man-machine interaction.

Function one is to display the CPU temperature, CPU fan speed, CPU voltage (monitored by the mainboard Hardware Monitor System) onto the LCD panel.

The other function of distance sensor will detect the distance between the body and the monitor. When the user comes too close to the computer monitor for a preset time or distance, the monitor will automatically power down to remind the user to stay at a proper distance. The monitor will resume again when the user moves outside the preset distance within the preset time. Or, the computer will automatically enter into standby mode when the user leaves the computer at a preset time and distance. The computer will automatically wake up again when the user returns to the preset distance within the preset length of time.

Function three is the Module's temperature sensor and light sensor will monitor the external environment and feedback the monitored results to the computer through the single chip and application software programming plus the timer and voice system featured in the computer, thereby bringing about interaction between hardware and software, and turning the computer into a humanized computer with man-machine interaction.

### SUMMARY OF THE INVENTION

The present invention is to build a Multifunction Humanized Interface Module through a single chip design and application software programming, the interface module will link up and work together with the computer. One of its functions is to display the CPU temperature, CPU fan speed and CPU voltage (featured on the mainboard) onto the LCD panel. This way, the user can clearly watch that CPU is working properly or not. Thanks to real time display of the monitored results on the LCD, the user can now readily know that the CPU is working properly without having the hassle of leaving the current operating environment and enter CMOS to see the working conditions of the CPU.

The other main function of this module is its distance sensor device. With this device, the monitor will automatically power down when the user comes too close to the Monitor (When Module is put right on the top of monitor) in a preset distance within a preset time. The display will automatically resume when the user stays at a proper distance. This purpose of this function is to remind the teens and kids they must maintain a certain distance from the monitor in order to protect their eyesight. Additionally, the computer and the monitor will both enter power down when user is not detected at a preset distance and length of time. The computer and monitor will automatically resume again when the user returns to the preset distance at a preset length of time.

A third main function of the module is performed by another set of environmental Temperature Sensor and Light Sensor plus Timer setting and Microphone input device built-in computer. The mentioned results of the environmental temperature, light, voice and timer will be transmitted to the computer mainboard via a single chip and the control of application software, and then link-up to the software to enable a more interesting hardware and software interaction.

For instance, we write an game of aquarium software into the computer. Through sensor, voice input and timer setting, the monitored resulted of temperature, light, voice and timer will be transmitted to the computer mainboard via the single chip and application software programming, and then link-up with aquarium software for creating special effect according to the software design requirement; thereby, bringing about natural changes of a real aquarium such as the rise and fall of temperature following weather conditions, and also to reflect the brightness of day and the darkness of night by both light sensor or timer setting. Additionally, each fish in the aquarium can be named and when their names are called, they will swim to the user upon the call. So, the fishes in the aquarium become humanized and is able to interact with the user.

To enable members of the Review Committee better understand the objectives, characteristics and function of this invention, we would like to further describe the invention along with the following diagrams.

### BRIEF DESCRIPTION OF THE DRAWINGS

Diagram 1. Layout circuit of Monitoring System, Power Management System, Near Distance Sensor, Temperature Sensor, Light Sensor, Microphone and Timer.

Diagram 2. Layout circuit of Far Distance Sensor.

Diagram 3. Illustrative Samples of this invention.

10 Mainboard
15 Mainboard Power Management System
20 Hardware Monitoring System (CPU Temperature, fan speed and
voltage)
30 Single Chip
40 Transmission Cable
45 LCD Panel
50 Near Distance Sensor Unit
55 Far Distance Sensor Unit
60 Temperature Sensor Unit
61 Light Brightness Sensor Unit
62 Microphone - Input Device
63 Timer
65 Application Software
70 Computer Monitor
71 Computer
75 Computer Software or Game Software
80 Humanized Multifunction Module

### DETAILED DESPRITION OF THE PREFFERRED EMBODIMENT

Diagram 1 illustrates this invention's CPU temperature, fan speed and voltage circuits.

CPU temperature, fan speed and voltage Monitoring System (20) is built in the mainboard (10). The monitored results (20) will be transmitted via a single chip (30) onto the LCD display unit (45) featured in humanized Interface Module (80).

Diagram 1 shows the other circuit diagram of the Near Distance Sensor.

When the Near Distance Sensor Unit (50) detects user within the preset distance or length of time, a signal will be sent to the mainboard (10) Power Management System (15) via the Single Chip (30) and cable (40). Through the Control of application software (65), the mainboard (10) will issue instruction to trigger the Monitor (70) into standby mode. Until the signal disappears, Application software (65) will issue another instruction to resume the Monitor.

Or when the Far Distance Sensor Unit (55) fails to detect object in the preset distance and length of time, it will issue a signal to the computer Mainboard (10) Power Management System (15) via the Single Chip (30). Through the control of Application Software (65), the Mainboard (10) will issue instruction to trigger the Monitor (70) and Computer (71) into standby mode. When object is detected in a specified length of time within the present distance, a signal will be issued to the computer Mainboard (10) Power Management System (15) again via the Single Chip (30). Through the control of Application Software (65), the signal received by the computer Mainboard (10) Power Management (15) will be identified and an instruction will be issued to resume the computer.

Diagram 1 shows another circuit diagram of Temperature Sensor, Light Sensor, Microphone input and Timer.

The Module's Temperature Sensor Unit (60) and Light Sensor Unit (61) plus Microphone (62) and Timer (63) built-in the Computer (71) will monitor the environmental temperature, light, voice and timer setting and then feedback the monitored results to the computer mainboard (10) through the control of Application Software (65) and single chip (30), and then link-up with Computer Software (75).

To sum up, the main objective of this invention is to provide a system to display CPU temperature, CPU fan speed, and CPU voltage via the link-up with mainboard Power Management System to enable the user to real time watch the CPU working situation. Additionally, the Near Distance Sensor device provides to protect eyesight for the teens and kids, and Far Distance Sensor for saving power. Finally, through the Module's Temperature and Light Sensors plus Computer's Microphone and Timer Setting to monitor environmental Temperature, Light, Voice and Timer, and transmit to the computer via the control of Application Software and Single Chip design.

Then, link-up with Computer Software, thereby a more interesting software or game will be achieved with intelligent man-machine interaction.

This invention is not only of practical use but is an unprecedented new design, fulfilling all the necessary requirements of the Patent Law. We hereby submit this invention to the Patent Review Committee for its careful consideration.

It is to be understood that, even though we have set forth an illustrative sample of this invention, the application of this invention does not restrict to the exemplified implementation. In accordance with what is claimed in our application for this invention, any changes or modifications to the invention shall also be covered by this invention.

What is claimed is:

1. A Humanized Multifunction Module providing to connect Computer Comprising:
A Single Chip;
A LCD Panel;
A Distance, Temperature and Light Sensor
An Application Software Program.

2. Through the Programming of an Application Software to catch the Mainboard Hardware Monitor System and transmitted the signal to Module's LCD Panel via the Single Chip.

3. A Near Distance Sensor as claimed in claim 1 is applied to detect the appearance of near object so that when object appears at a preset distance and time, the Sensor will issue a signal to the computer mainboard via Single Chip; and then through the programming of signal to control the Power Down or Resume a Monitor.

4. A Far Distance Sensor as claimed in claim 1 is applied to detect disappearance of the far object so that hen object disappears at a preset distance and time, the Sensor will issue a signal to the computer mainboard via Single Chip; then through the programming of signal to control the Power Down or Resume Computer.

5. A Temperature and Light Sensor as claimed in claim is applied to detect environmental temperature and light, and transmitted to computer via the Single Chip and the control of Application Software in order to reach interaction between hardware and software.
